(19) United States
(12) Patent Application Publication
(10) Pub. No.: US 2025/0223024 A1
(43) Pub. Date: Jul. 10, 2025

(54) 3D Printed Core

(71) Applicant: Textron Aviation Inc., Wichita, KS (US)

(72) Inventors: Gene Paulsen, Wichita, KS (US); Jesse Scott Weiss, Wichita, KS (US); Rodolfo Coronado, Wichita, KS (US); Joseph Felts, Wichita, KS (US)

(21) Appl. No.: 19/011,497

(22) Filed: Jan. 6, 2025

Related U.S. Application Data
(60) Provisional application No. 63/618,759, filed on Jan. 8, 2024.

(51) Int. Cl. B64C 1/00

(52) U.S. Cl. CPC B64C 1/00; B64C 2001/0045; B64C 2001/0072

(57) ABSTRACT

A 3D printed core is provided for a sandwich panel component. The 3D core includes a mesh structure with interconnected segments having vertical facets with bonding surfaces for adhering to aircraft skin layers. A height of the vertical facets may be varied for varying a thickness of the mesh structure. The bonding surfaces of each vertical facet may include a channel for forming parallel bond lines opposite the channel.

### CROSS-REFERENCE TO RELATED APPLICATIONS

This application claims the benefit of U.S. Provisional Patent Application No. 63/618,759, filed Jan. 8, 2024, the entire contents thereof are herein incorporated by reference.

### BACKGROUND

### 1. Field

Embodiments of the invention relate generally to the field of aircraft manufacturing. More specifically, the disclosed embodiments relate to using 3D printing techniques in aircraft manufacturing.

### 2. Related Art

It is known for truss members of an aircraft to be 3D printed. For example, U.S. Pat. No. 9,745,736 to Wadley et al. discloses three-dimensional space frames and methods of manufacture. Wadley discloses truss structures may be used as the interior load-bearing members of a sandwich panel. The truss members may be formed using 3D printing processes.

It is also known to manufacture composites using 3D printing techniques. For example, U.S. Pat. No. 10,259,160 to Mark discloses the manufacture of composite structures and the equipment and methods of 3D printing techniques. Mark describes that the interior structure of a sandwich panel may be formed using a 3D printing process.

It is also known to form an internal stiffener using 3D printing techniques. For example, U.S. Pat. No. 10,556,670 to Koppelman et al. discloses the manufacture of laminar flow panels used in aircraft. The internal stiffener structure supports the skin of the panel rather than forming the internal support structure. The internal stiffener structure may be 3D printed.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1A shows a 3D printed core attached to a spar structure in accordance with embodiments of the present disclosure;

FIG. 1B shows the 3D printed core of FIG. 1A;

FIG. 1C shows another perspective view of the 3D printed core of FIG. 1A;

FIG. 1D is a close up perspective view of the 3D printed core of FIG. 1A;

FIG. 1E shows a rear perspective view of the 3D printed core of FIG. 1A;

FIG. 1F shows a side perspective view of a siding structure mounted onto the 3D printed core of FIG. 1A;

FIG. 2A shows a stack including an alternative embodiment of the 3D printed core positioned in between a top skin layer and a bottom skin layer;

FIG. 2B shows a view of the stack of FIG. 2A with a portion of the top skin layer removed;

FIG. 3 shows a perspective view of an alternative embodiment of the 3D printed core;

FIG. 4A shows a perspective view of a splice clip;

FIG. 4B shows a perspective view of the splice clip partially inserted into the 3D printed core of FIG. 3;

FIG. 5 shows a perspective view of an alternative embodiment of the 3D printed core; and

FIG. 6 shows a high-level method flow for having a 3D printed core.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Aircraft skin panels, including flight control surfaces, are typically manufactured using a sandwich panel design construction with a top skin layer, a bottom skin layer, and a core layer. The core layer in between the top skin layer and the bottom skin layer may be made from a Nomex® (DuPont) type material. A Nomex® core may be suboptimal because of the difficulty of machining the Nomex® material into non-rectangular configurations and the inability of the Nomex® core to repel moisture. A solution is needed which involves fabricating the core from a moisture resistant material which may be easily manufactured into complex shapes.

Embodiments disclosed herein provide a system and method for having a 3D printed core. The 3D printed core in embodiments is formed by employing 3D printing techniques to grow the core to its desired size and geometry. 3D printing the core allows the core to be formed into complex shapes or geometries while being able to substantially hold its form to a greater degree, compared to if formed using previous manufacturing techniques. The 3D printed core may be fabricated from a moisture resistant material and may be able to be produced at a lower cost when compared to current manufacturing techniques. The 3D printed core may be used as a middle layer in between aircraft skin layers for aircraft flight control surfaces. Additionally, the disclosed techniques enable formation of previously unattainable features in the core structure, such as forming parallel bond lines in a top surface of the core structure for bonding with a skin layer.

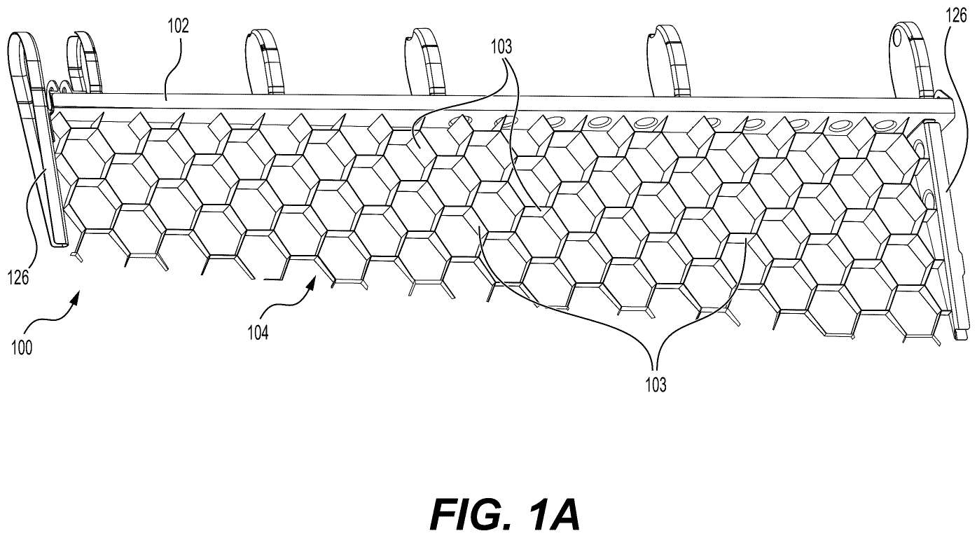

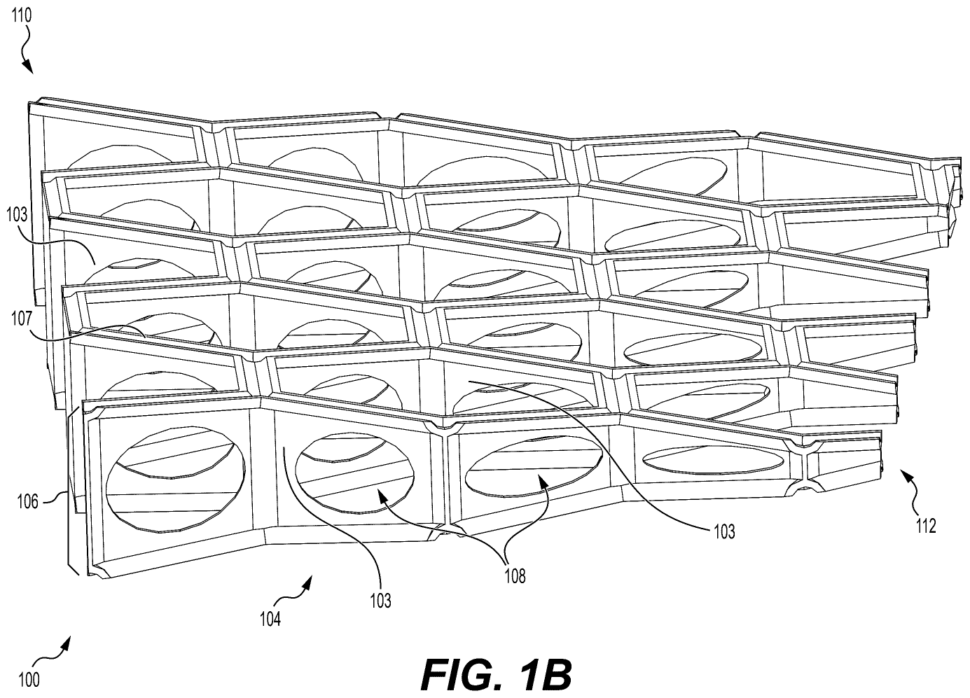

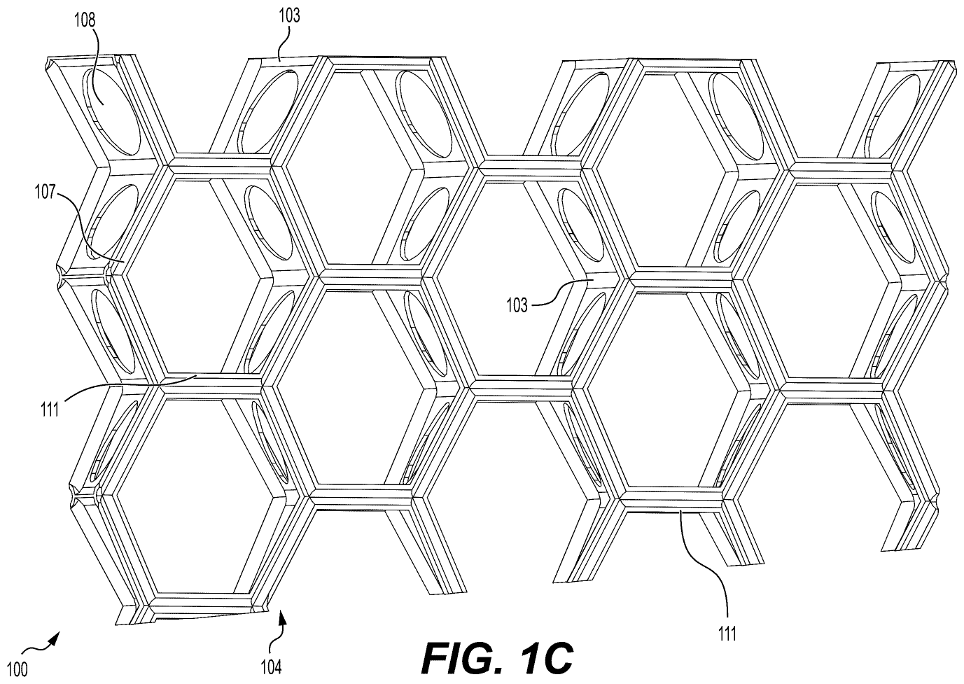

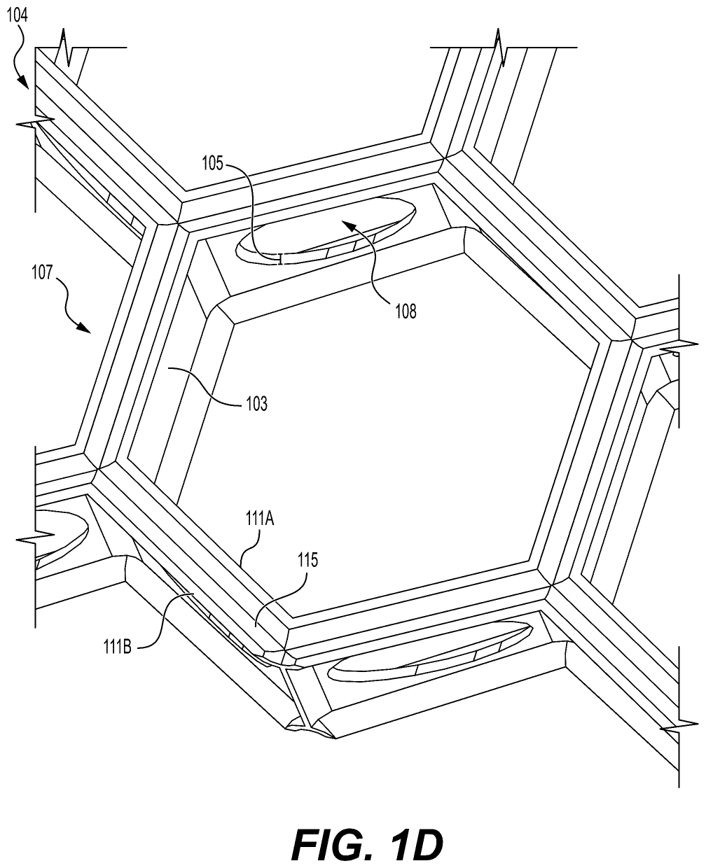

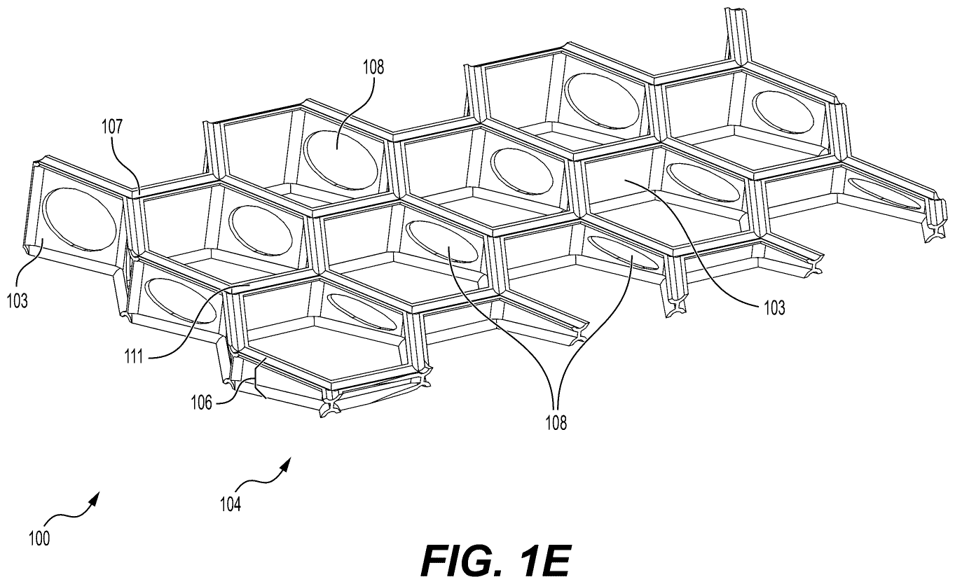

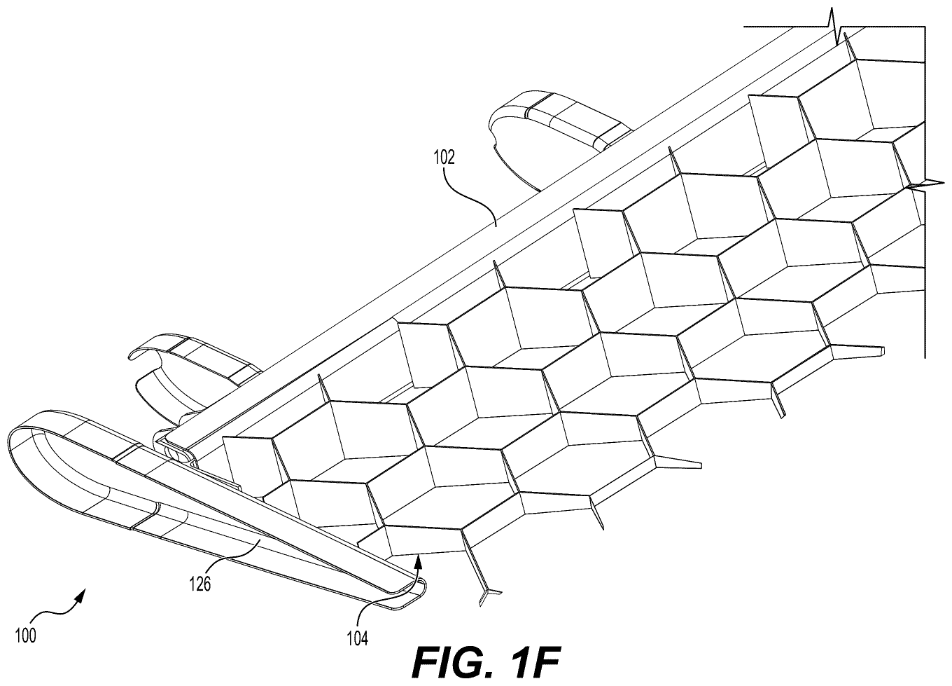

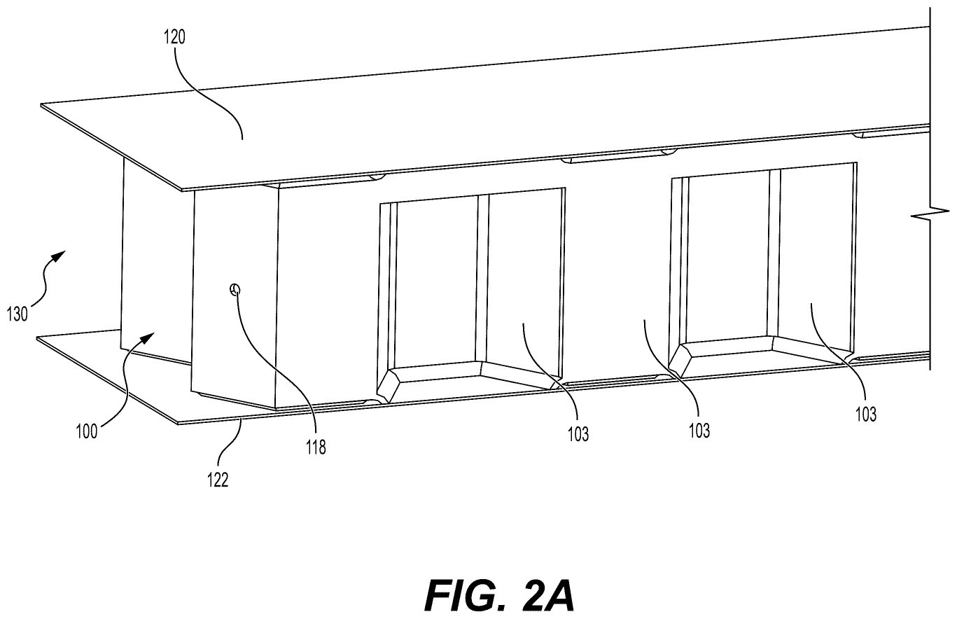

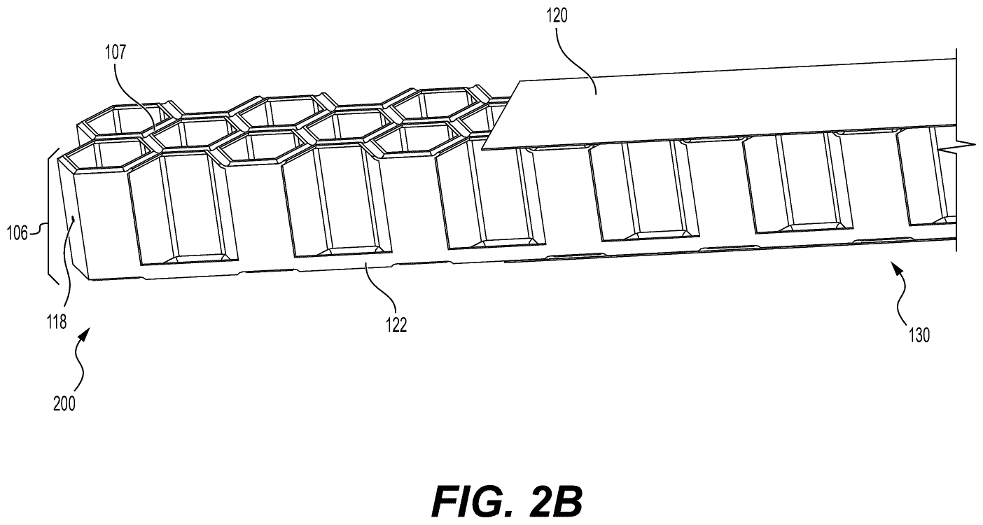

FIG. 1A shows a perspective view of the 3D printed core 100 shown in relation to spar and rib structure 102 with skins removed for visual clarity. The 3D printed core 100 in embodiments includes a mesh structure 104 having interconnected segments configured to provide support between two skin layers (see FIG. 2A). The mesh structure 104 in embodiments is a structure having interconnected segments with vertical facets 103 arranged in patterns, with numerous segments being repeated and interconnected. In embodiments, the vertical facets 103 are arranged as vertically oriented walls forming the sides of the interconnected segments, with each of the interconnected segments being arranged to form one or more shapes (e.g., hexagonal, diamond, iso-grid, etc.). As depicted in FIGS. 1A-1E, the interconnected segments are aligned in a series of columns and rows. Adjacent rows and columns may be offset such that the segments of every other row are aligned with one another, and the segments of every other column are aligned with one another.

In embodiments, the mesh structure 104 of the 3D printed core 100 is attached to spar structure 102. The spar structure 102 may comprise any structural member used in a sandwich panel design construction. The mesh structure 104 may be formed from a material such as ULTEM (Polytherimide), PETG (Polyethylene terephthalate glycol), Nylon, PEEK (Polyether ether ketone) and numerous other plastics and fiber systems. These materials may be moisture resistant to prevent mesh structure 104 from increasing in mass. The 3D printed core 100 can be grown to size using a 3D printer or other additive manufacturing technique. As a result of the capability to grow the 3D printed core 100 to a desired size using a 3D printer or other additive manufacturing tool, the mesh structure 104 does not need to be cut or tapered for the 3D printed core 100 to reach its desired size. In some embodiments, the 3D printed core 100 may be a flight control surface and may be configured to operate as an elevator, flap, aileron, rudder or other pivotable aircraft surface.

FIG. 1B shows a side perspective view of the mesh structure 104 of the 3D printed core 100. The vertical facets 103 forming the mesh structure 104 have a height 106 which is a distance between a top bonding surface 107 of and a bottom bonding surface 109 of the mesh structure 104. In embodiments, the height 106 of the vertical facets 103 varies between opposing ends of the mesh structure 104 and thus the thickness of the mesh structure 104 varies according to the height 106 of vertical facets 103. For example, the height 106 may vary from approximately 0.1 to twelve inches thick in embodiments; in other embodiments, the height 106 may vary from approximately 0.1 to six inches thick. In embodiments, the height 106 of the mesh structure 104 of the 3D printed core 100 gradually decreases such that a forward end 110 is thickest and the aft end 112 is thinnest. For example, the height 106 may monotonically decrease from one end to the other, or the height 106 may linearly decrease from one end to the other. The mesh structure 104 has a width 105 (see FIG. 1D) which is a distance across a vertical facet 103. In embodiments, the width 105 may be approximately 0.02 to 0.25 inches wide. In some embodiments, the mesh structure 104 includes lightening holes 108 removed from vertical facets 103 forming the mesh structure 104. The lightening holes 108 are configured to decrease the weight of the mesh structure 104.

FIG. 1C shows another perspective view of the 3D printed core 100. The top bonding surface 107 shown in FIG. 1C may be substantially the same as the bottom bonding surface 109 each forming the upper and lower edges of the vertical facets 103 respectively. The top bonding surface 107 and the bottom bonding surface 109 are each bonding surfaces configured to be bonded to skin layers 120 and 122 (FIGS. 2A and 2B). Bonding surfaces 107 and 109 extend across and overhang each wall of facet 103 creating an “I” shape. The top bonding surface 107 and possibly the bottom bonding surface 109 include bond lines 111. The bond lines 111 are substantially redundant across the top bonding surface 107. As shown in FIG. 1D, a partial recess or channel 115 is formed in the top bonding surface 107 such that parallel bond lines 111A and 111B extend along opposite sides of the channel 115. In embodiments, the parallel bond lines 111A/111B may increase the failure resistance of the 3D printed core 100, and when under stress, the parallel bond lines 111A/111B may assist with fractures forming first within the mesh structure 104 rather than occurring within a top skin layer 120 or a bottom skin layer 122 (shown in FIGS. 2A and 2B). In embodiments, the channel 115 and bond lines 111 may be interconnected at locations where the vertical facets 103 of mesh structure 104 are joined together. In some embodiments, the mesh structure 104 may be arranged such that the interconnected segments and vertical facets 103 are arranged in a hexagonal pattern which allows for the channels 115 of each facet 103 to be interconnected such that a channel network is formed throughout the bonding surfaces 107, 109 of the mesh structure 104. An adhesive may be applied into the channel 115 and on outer surfaces of bond lines 111 to bond to top skin layer 120 and bottom skin layer 122. In embodiments, the channel 115 is a V-shaped channel, but in other embodiments the channel 115 may be U-shaped, or have a variety of other shapes.

FIG. 1E shows a rear perspective view of the 3D printed core 100. In embodiments, the lightening holes 108 formed into the vertical facets 103 of the mesh structure 104 have a varying shape based upon the height 106 of the mesh structure 104. For instance, in embodiments, the forward side of the mesh structure 104 (i.e., where the mesh structure 104 is the thickest) the lightening holes 108 are substantially more circular than the lightening holes 108 positioned towards the aft side of the mesh structure 104 where the mesh structure 104 is the thinnest. In other words, the lightening holes 108 may all be elliptically shaped and share a similar major axis but have a varying minor axis depending on the height 106 of the mesh structure 104, in embodiments. The lightening holes 108 are also only formed on the aft or forward-facing vertical facets 103 of the mesh structure 104 and not on the side-facing vertical facets 103 of the mesh structure 104, in embodiments. In other embodiments lightening holes 108 may be disposed into the side-facing vertical facets 103 of mesh structure 104. In some embodiments, as shown in FIG. 1F, the thinnest end of the 3D printed core 100 is opposite the spar structure 102. In some embodiments, a siding structure 126 can be mounted to the sides of the mesh structure 104. The siding structure 126 has a slope to match the slope of the varying height of mesh structure 104. In some embodiments, the top skin layer 120 and bottom skin layer 122 (FIGS. 2A and 2B) may be bonded to the siding structure 126.

FIG. 2A is a side perspective view of an alternative embodiment of the 3D printed core 200 with a top skin layer 120 and a bottom skin layer 122. The top and bottom skin layers 120 and 122 may be fabricated from a pre composite fabric with the top skin layer 120 being laid onto the top bonding surface 107 of the mesh structure 104 and the bottom skin layer 122 being laid onto the bottom bonding surface 109 of the mesh structure 104. The top skin layer 120, the bottom skin layer 122, and the 3D printed core 200 form a stack 130 with the 3D printed core 200 being sandwiched between the top skin layer 120 and bottom skin layer 122. In the embodiment shown in FIG. 2A, the vertical facets 103 of the mesh structure 104 are shown without lightening holes 108. In some embodiments, the mesh structure 104 of the 3D printed core 200 may include an indentation 118 disposed in one of vertical facets 103 to provide reference for a tool when the 3D printed core 200 is being installed in an aircraft assembly.

FIG. 2B shows another perspective view of the 3D printed core 200 of FIG. 2A. Shown in FIG. 2B the top skin layer 120 is partially removed from the 3D printed core 200 revealing the top bonding surface 107. Lightening holes 108 are not shown on vertical facets 103 in the mesh structure 104 but could be added, and the height 106 of the 3D printed core 200 is constant but could be modified to vary like with 3D printed core 100.

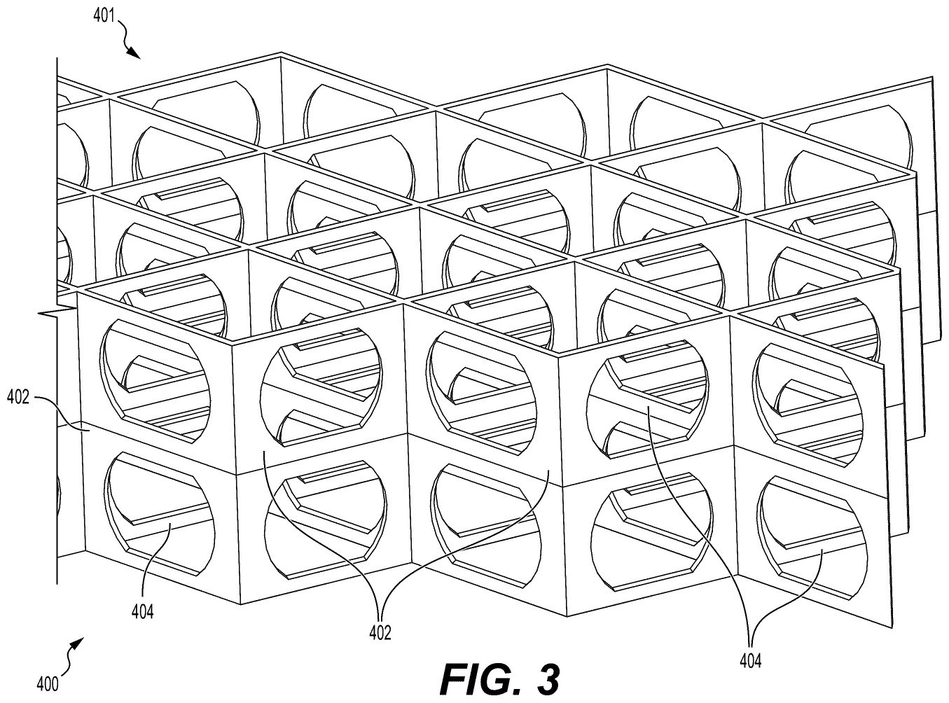

FIG. 3 is a side perspective view of an alternative embodiment of the 3D printed core 400. The 3D printed core 400 includes a mesh structure 401 having vertical facets 402 arranged in a diamond lattice configuration. Each vertical facet 402 includes two lightening holes 404 vertically aligned with one another and positioned centrally on the faces of the vertical facets 402. In embodiments, the lightening holes 404 are oblongly shaped having curved ends and horizontally aligned sides.

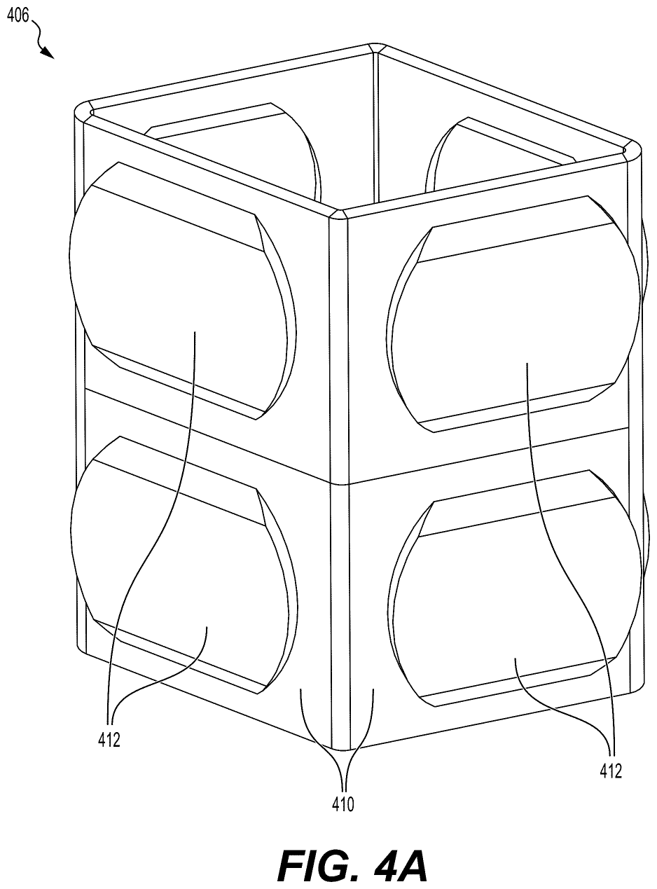

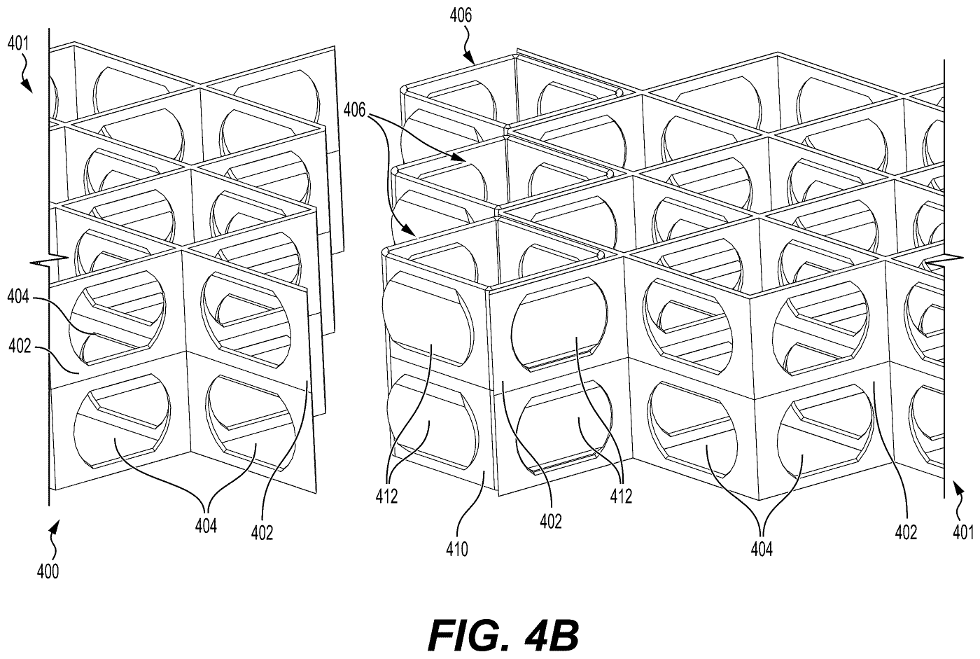

FIG. 4A shows a perspective view of a splice clip 406 which may be used to join sections of mesh structure 401 together. Each splice clip 406 includes four vertical facets 410 arranged in a diamond lattice shape. The splice clip 406 is configured to fit in between the four vertical facets 402 arranged to form a single diamond lattice of the mesh structure 401. The four vertical facets 410 of the splice clip 406 each include bulged portions 412 projecting outwards from the walls of the vertical facets 410. In embodiments, two bulged portions 412 are centrally positioned and extend away from the exterior face of each of the four vertical facets 410 and are shaped to insert into the lightening holes 404 when inserted into a diamond lattice of the mesh structure 401.

FIG. 4B shows the splice clip 406 partially inserted into the mesh structure 401. In embodiments, three splice clips 406 are shown. For instance, when splicing sections of mesh structure 401 together, one section of mesh structure 401 may have two vertical facets 402 configured to align with two vertical facets 402 on another section of the mesh structure 401. The aligned vertical facets 402 of each section may be aligned to form a diamond lattice shared between the adjacent sections such that the splice clip 406 is inserted in between the four aligned vertical facets 402. FIG. 4B shows the splice clip 406 wherein the bulged portions 412 are inserted into the lightening holes 404 of the vertical facets 402 such that a section of the mesh structure 401 is secured to the splice clip 406. Another section of the mesh structure 401 is separated from the splice clip 406 revealing the vertical facets 410 of the splice clip 406. The splice clip 406 may be advantageous for sections of core to be spliced together in assemblies requiring a larger 3D printed core 400 than the size able to be produced from an additive machine. A film or paste adhesive may be used to further secure the splice clip 406 to the mesh structure 401. The splice clip 406 provides a load path to occur from one section of mesh structure 401 to another while substantially controlling the positioning of the mesh structures 401.

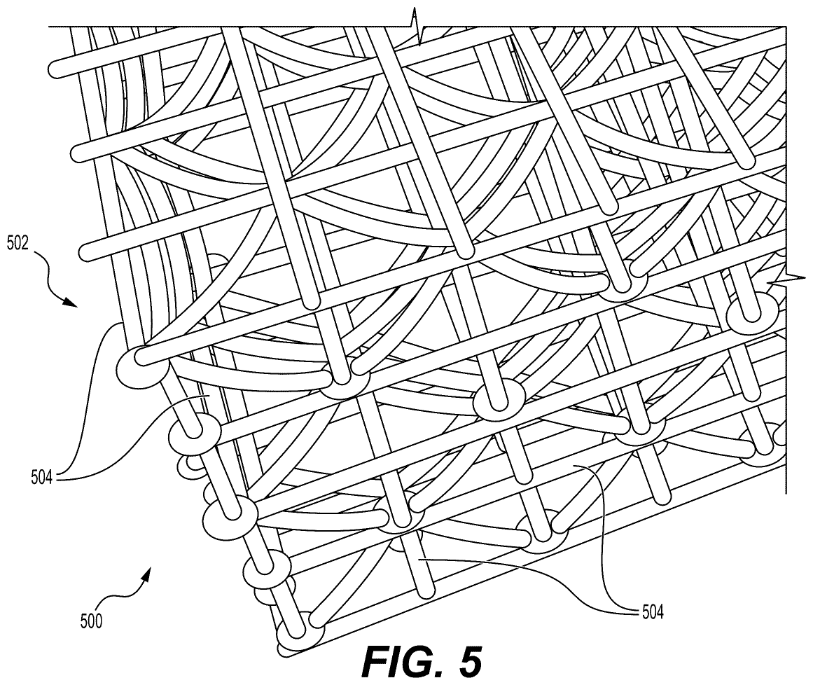

FIG. 5 shows an alternative embodiment of the 3D printed core 500. The 3D printed core 500 includes a mesh structure 502 having segments 504. In embodiments, the segments 504 are configured into cubical shapes arranged to form an isogrid structure. Some segments 504 are positioned horizontally while others are positioned vertically, all connecting on ends to form cube structures. Other segments 504 extend diagonally across the cube structures. In embodiments, the mesh structure 502 and segments 504 do not have vertical facets as in 3D printed core 100, 200, and 400.

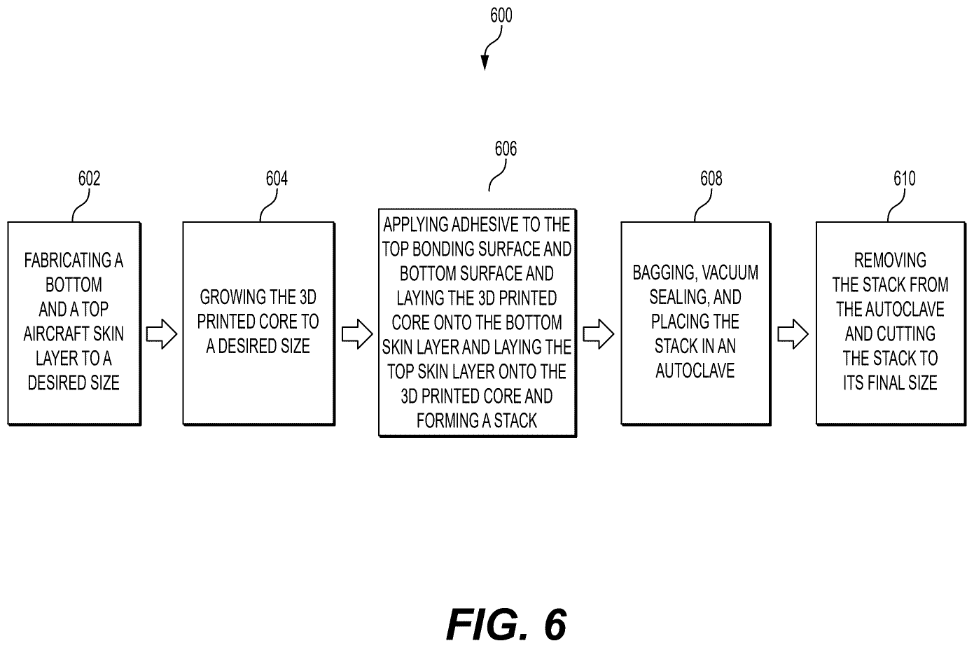

FIG. 6 is a high-level method flow diagram 600 for fabricating a 3D printed core 100, in embodiments. Although in the method 600 the 3D printed core 100 is referred to, it should be known that the method is also applicable to 3D printed core 200 and the 3D printed core 400, and the 3D printed core 500. The order of steps for method 600 may be modified without departing from the scope hereof.

In a step 602, the bottom and top aircraft skin layers 120 and 122 (FIG. 2A) are fabricated to a desired size and shape. In embodiments, the bottom and top aircraft skin layers may be fabricated from a pre-composite fabric and may be cut to size using a tool such as a router. In some embodiments, the bottom and top skin layers 120 and 122 may be fabricated from a single piece of material.

In a step 604, the 3D printed core 100 is grown using a 3D printer. The 3D printed core 100 may be formed into a complex shape having segments which form a mesh structure 104. The 3D printed core 100 may be fabricated from a material such ULTEM, PETG, Nylon, or PEEK which may be moisture resistant and may allow the mesh structure 104 to substantially maintain its shape. The 3D printed core 100 may comprise a tapered thickness with a linearly decreasing thickness from one side to the other. The 3D printed core 100 may also comprise lightening holes 108, which may be formed during step 604. Alternatively, lightening holes 108 may be cut out of vertical facets 103 of the mesh structure 104 following step 604.

In a step 606, the bottom bonding surface 109 of the 3D printed core 100 is laid onto the bottom skin layer 122 and the top skin layer 120 is laid onto the top bonding surface 107 of the 3D printed core 100 creating a stack 130 (FIG. 2A). In some embodiments, a layer of adhesive may be distributed in between the bottom bonding surface 109 and the bottom skin layer 122 of the 3D printed core 100 and a layer of adhesive may be distributed in between the top skin layer 120 and the top bonding surface 107 of the 3D printed core 100. In some embodiments, the 3D printed core 100 may be co-cured with pre-preg composite skins (i.e. the skins have been pre-applied with an adhesive such as epoxy). In this case, adhesive may not be applied to the bonding surface 107 and 109.

In a step 608, the stack 130 is bagged, placed in a vacuum, and then placed into an autoclave. The stack 130 is cured in the autoclave with the bottom skin layer being bonded to the bottom bonding surface 109 of the 3D printed core 100 and the top skin layer being bonded to the top bonding surface 107 of the 3D printed core 100. Following step 608, the 3D printed core 100 is bonded in between the top bonding surface 107 and bottom bonding surface 109 of the stack 130.

In a step 610, the stack 130 is removed from the autoclave and debagged. In some embodiments, the 3D printed core 100 may be cut to its final size. The 3D printed core 100 allows for the stack 130 to be lightweight and substantially moisture resistant for usage on aircraft surfaces such as flight control surfaces. The stack 130 may be of a sandwich panel design construction.

Although the invention has been described with reference to the embodiments illustrated in the attached drawing figures, it is noted that equivalents may be employed and substitutions made herein without departing from the scope of the invention as recited in the claims. It will be understood that certain features and sub-combinations are of utility and may be employed without reference to other features and sub-combinations and are contemplated within the scope of the claims. Not all steps listed in the various figures need be carried out in the specific order described.

Having thus described various embodiments of the invention, what is claimed as new and desired to be protected by Letters Patent includes the following:

What is claimed is:

1. A 3D printed core structure for a sandwich panel component, the 3D printed core structure comprising:
a mesh structure having a plurality of interconnected segments, wherein the interconnected segments include vertical facets having a top bonding surface opposite a bottom bonding surface, each bonding surface being configured to adhere to an aircraft skin layer; and
the vertical facets comprise a height that varies gradually between a first end and a second end such that the mesh structure has a thickness that varies according to the height of the vertical facets.

2. The core structure of claim 1, wherein the top bonding surface and the bottom bonding surface each include a channel such that a pair of bond lines extend along the top and bottom bonding surfaces on opposing sides of the channel.

3. The core structure of claim 2, wherein the top and bonding surfaces are configured to receive an adhesive within the channel and on outer surfaces of the pair of bond lines to adhere to the aircraft skin layers and increase the failure resistance of the mesh structure.

4. The core structure of claim 1, comprising a spar structure attached to periphery edges of the mesh structure and configured to provide support for the mesh structure.

5. The core structure of claim 1, wherein the mesh structure has a thick end and a thin end due to the varying height of the vertical facets.

6. The core structure of claim 5, comprising a siding structure configured to support the sides the mesh structure.

7. The core structure of claim 6, wherein the siding structure comprises a varying height to match the varying height of the mesh structure from its thin end to its thick end.

8. The core structure of claim 1, comprising an indentation disposed in at least one of the vertical facets, wherein the indentation is configured to provide a reference point for a tool.

9. The core structure of claim 1, comprising a lightening hole formed into one or more of the vertical facets.

10. The core structure of claim 9, comprising a splice clip having more than one segment, wherein each segment comprises a bulge portion that projects outwardly from a wall portion, the bulge portion being configured to insert into a lightening hole, such that the splice clip is configured to connect two adjoining sections of the mesh structure together.

11. The core structure of claim 1, wherein the interconnected segments are arranged vertically and horizontally into an isogrid configuration.

12. The core structure of claim 1, wherein the interconnected segments and the vertical facets are arranged into a diamond lattice configuration.

13. A core structure for a sandwich panel component, the core structure comprising:
a mesh structure having a plurality of interconnected segments, wherein the interconnected segments include vertical facets having a top bonding surface and a bottom bonding surface, each configured to adhere to an aircraft skin layer; and
a channel formed in the top bonding surface and the bottom bonding surface such that a pair of bond lines is formed on opposing sides of the channel.

14. The core structure of claim 13, wherein a height of the vertical facets varies gradually between a first end and a second end of the mesh structure such that a corresponding thickness of the mesh structure varies between the first end and the second end.

15. The core structure of claim 13, wherein each bond line of the pair of bond lines are aligned parallel to one another within each vertical facet.

16. The core structure of claim 13, wherein the interconnected segments are arranged in a hexagonal pattern.

17. The core structure of claim 13, wherein the channels formed into the top and bottom bonding surfaces of the vertical facets are interconnected forming channel networks throughout each of the bonding surfaces.

18. The core structure of claim 13, wherein the top bonding surface and the bottom bonding surface extend across and overhang a wall portion of the vertical facets and create an “I” shape.

19. The core structure of claim 13, wherein the mesh structure is formed using an additive manufacturing technique, such as printing via a 3D printer.

20. The core structure of claim 13, wherein the channel is a V-shaped channel.
